(19) United States
(12) Patent Application Publication
(10) Pub. No.: US 2026/0261618 A1
(43) Pub. Date: Sep. 3, 2026

(54) IMAGE FORMING APPARATUS

(71) Applicant: SHARP KABUSHIKI KAISHA, Sakai City (JP)

(72) Inventor: Daisuke NAGO, Sakai City (JP)

(21) Appl. No.: 19/554,816

(22) Filed: Mar. 3, 2026

(30) Foreign Application Priority Data
Mar. 3, 2025 (JP) 2025-032993

(51) Int. Cl. H04N 1/00

(52) U.S. Cl. CPC H04N 1/00076; H04N 1/00037; H04N 1/0049; H04N 1/00689; H04N 1/00692; H04N 1/00708; H04N 1/00766; H04N 1/00771

(57) ABSTRACT

An image forming apparatus comprising one or a plurality of controllers, when a document cover is opened at start of the job, allows a storage to store the size of the document detected by a document size detector, after completion of the job, in a case where a document cover opening/closing detector detects that the document cover is opened before a predetermined standby time elapses, the document size detector is allowed to detect the size of the document again, and in a case where the document is detected, an unremoved document notification provider is allowed to notify that the document is forgotten to be removed, and , in a case where even after the standby time has elapsed, the document cover opening/closing detector does not detect that the document cover is opened, the unremoved document notification provider is allowed to notify that the document is forgotten to be removed.

### CROSS-REFERENCE TO RELATED APPLICATION

The present application claims priority from Japanese Application JP 2025-032993, the content of which is hereby incorporated by reference into this application.

### BACKGROUND OF THE INVENTION

### Field of the Invention

The disclosure relates to an image forming apparatus, and more particularly, to an image forming apparatus having a function of preventing forgetting to remove a document.

### Description of the Related Art

In the related art, in a multifunction apparatus installed in a store such as a convenience store or a public facility such as a library or a city hall, a problem that a user forgets to remove a document after using the multifunction apparatus is often reported. Forgetting to remove a document causes a problem of leakage of personal information of a user or loss of privacy, and also causes a problem of an increase in workload for an employee or a staff member to cope with the document forgotten to be removed.

As a method for preventing forgetting to remove a document as just described, there is a known technique to notify a user that a document is left behind on a document table of a multifunction apparatus by displaying on a screen an image or animation that prompts prevention of the document forgotten to be removed or by giving an audio warning during printing or at the end of a service.

For example, there is proposed an image forming apparatus that includes notification means that notifies a user that a document is forgotten to be removed when it is detected that a discharged sheet is removed from a discharge tray in a state where a document cover is not opened.

Further, there is proposed an image processing apparatus characterized by including print permission means. In a case where opening/closing detection means detects opening/closing of a document cover after the start of copying is instructed, the print permission means determines that a document is removed, and then permits print processing.

Furthermore, there is proposed a printer with a scanner. After printing an image or after storing a scanned document image in storage means when continuous scanning is set, the printer checks whether a document cover is opened or closed, and if the document cover is not opened or closed, the printer determines that the document is forgotten to be removed and notifies a user that the document is left behind.

### SUMMARY

However, in a case where an image or animation that prompts prevention of the document forgotten to be removed is displayed on the screen, the user who does not view the screen after the service is finished may not notice the image or animation. Even if a warning is given by voice or a notification sound, the warning may be difficult to hear in a noisy environment such as the inside of a convenience store. As a result, the user is likely to forget to remove the document without noticing the warning.

Further, in a method in which copying is not started until a document is removed, a user needs to remove the document when the user copies the same document again, which is not only inconvenient but also may cause the position of the document to be changed when the user places the document again.

Furthermore, there is a method for determining the presence or absence of a document by executing pre-scanning and notifying a user of the determination result. However, processing runs slowly as pre-scanning is executed. In addition, not only it takes at least several seconds to read the document, but also power is consumed. Therefore, a problem of shortening the life of the multifunction apparatus may occur.

The present disclosure is made in view of the above circumstances, and an object of the disclosure is to provide an image forming apparatus that effectively prevents forgetting to remove a document with less power consumption than in the related art without impairing user convenience.

### Solution to Problem

The disclosure provides an image forming apparatus including: an operation inputter that receives an execution command of a service involving reading of a document from a user; a document reader that reads the document placed on a document table and generates image data based on an execution command of a job related to the service; an image outputter that outputs an image formed based on the image data; a document size detector that detects a size of the document placed on the document table; a storage that stores the size of the document; a document cover opening/closing detector that detects opening/closing of a document cover of the document table; an unremoved document notification provider that notifies that the document is forgotten to be removed from the document table; and one or a plurality of controllers that control the operation inputter, the document reader, the image outputter, the document size detector, the storage, the document cover opening/closing detector, and the unremoved document notification provider. When the document cover opening/closing detector detects that the document cover is opened at start of the job, the controller allows the storage to store the size of the document detected by the document size detector. After completion of the job, in a case where the document cover opening/closing detector detects that the document cover is opened before a predetermined standby time elapses, the document size detector is allowed to detect the size of the document again, and in a case where the document is detected, the unremoved document notification provider is allowed to notify that the document is forgotten to be removed. On the other hand, in a case where even after the standby time has elapsed, the document cover opening/closing detector does not detect that the document cover is opened, the unremoved document notification provider is allowed to notify that the document is forgotten to be removed.

### Advantageous Effects of Disclosure

According to the disclosure, after the completion of a job involving reading of the document, when it is detected that the document cover is opened before the predetermined standby time elapses, the size of the document is detected again and the document is detected. In this case, the user is notified that the document is forgotten to be removed. On the other hand, when it is not detected even after the standby time has elapsed that the document cover is opened, the user is notified that the document is forgotten to be removed. As a result, the image forming apparatus can be achieved that effectively prevents forgetting to remove the document with less power consumption than in the related art without impairing user convenience.

### BRIEF DESCRIPTION OF THE DRAWINGS

FIG. 1 is a perspective view illustrating an external appearance of a digital multifunction apparatus according to a first embodiment of the disclosure.

FIG. 2 is a block diagram illustrating a schematic configuration of the digital multifunction apparatus of FIG. 1.

FIG. 3 is an explanatory diagram illustrating an example of a document size detector and a document cover opening/closing detector that are provided on a document table of the digital multifunction apparatus of FIG. 1.

FIG. 4 is a flowchart illustrating an example of document removal forgetting prevention processing by the digital multifunction apparatus of FIG. 1.

FIG. 5 is a flow chart illustrating an example of document removal forgetting prevention processing by the digital multifunction apparatus of FIG. 1.

### DETAILED DESCRIPTION OF THE INVENTION

In the disclosure, an "image forming apparatus" is a system that forms and outputs an image, such as a copy machine having a copier function (copying function), such as a printer that uses an electrophotographic method for forming an image with toner, or a multifunction peripheral (MFP) also having functions other than copying.

The "service involving reading of a document" includes, for example, services such as copying, scanning, e-mail transmission, and FAX transmission.

In addition, preferred aspects of the disclosure will be described.

In the image forming apparatus according to the disclosure, the document size detector may detect the size of the document, which is a predetermined size or larger. When the document cover opening/closing detector detects that the document cover is opened at the start of the job, the controller may allow the storage to store the size of the document, which is detected by the document size detector and is the predetermined size or larger. After the completion of the job, in a case where the size of the document, which is the predetermined size or larger is not stored in the storage, the document reader may be allowed to read the document placed on the document table if the document cover opening/closing detector detects opening/closing of the document cover before the standby time elapses, and in a case where the document is detected, the unremoved document notification provider may be allowed to notify that the document is forgotten to be removed.

The "predetermined size" is, for example, a size such as a A5 size or a B5 size.

Examples of the size smaller than the predetermined size include sizes of a business card, a driver’s license, a My Number Card, an L-size/2L size photograph, and the like.

Thus, even in a case where the document size detector cannot detect the size of the document smaller than the predetermined size, the size of the document, which is the predetermined size or larger is not stored in the storage after the completion of the job. In this case, the document reader is allowed to read the document placed on the document table if the document cover opening/closing detector detects opening/closing of the document cover before the standby time elapses, and when the document is detected, the unremoved document notification provider notifies that the document is forgotten to be removed. As a result, the image forming apparatus can be achieved that effectively prevents forgetting to remove the document with less power consumption than in the related art without impairing user convenience.

In the image forming apparatus according to the disclosure, after the completion of the job, the size of the document, which is the predetermined size or larger is not stored in the storage, and in such a case, if the document cover opening/closing detector detects opening/closing of the document cover before the standby time elapses, the controller may allow the document reader to read the document placed on the document table in a predetermined range smaller than the predetermined size.

Thus, after the completion of the job, the size of the document, which is the predetermined size or larger is not stored in the storage, and in such a case, if the document cover opening/closing detector detects opening/closing of the document cover before the standby time elapses, the document reader is allowed to read the document placed on the document table in the predetermined range smaller than the predetermined size. As a result, the image forming apparatus can be achieved that effectively prevents forgetting to remove the document with less power consumption than in the related art without impairing user convenience.

In the image forming apparatus according to the disclosure, the unremoved document notification provider may include a light emitter provided around the document cover, and after an end of the service is confirmed, the light emitter may be blinked to notify that the document is forgotten to be removed.

In the "confirmation of the end of the service", for example, in a case where a service end button displayed on the screen of the service is pressed, or a case where after the completion of a job related to the service, a predetermined standby time has elapsed in a state where no operation is received from the user, the controller determines that the end of the service is confirmed.

Thus, by blinking the light emitter provided around the document cover after the end of the service is confirmed and thereby notifying that the document is forgotten to be removed, the image forming apparatus can be achieved that effectively prevents forgetting to remove the document with less power consumption than in the related art without impairing user convenience.

The unremoved document notification provider may include a speaker and output a predetermined notification sound to notify that the document is forgotten to be removed.

In the image forming apparatus according to the disclosure, a display that previews the document read by the document reader to a user may be further provided. The controller may allow the storage to store the size of the document detected by the document size detector; thereafter, may allow the document reader to read the document placed on the document table, allow the display to preview the document, and allow the unremoved document notification provider to blink the light emitter. After the completion of the job, the document reader may be allowed to read the document placed on the document table before the standby time elapses, and in a case where the document is not detected, the unremoved document notification provider may be allowed to turn off the light emitter.

Thus, by previewing the document and thereafter blinking the light emitter provided around the document cover, reading the document after the completion of the job, and thereafter, if the document is not detected, allowing the unremoved document notification provider to turn off the light emitter, the image forming apparatus can be achieved that effectively prevents forgetting to remove the document with less power consumption than in the related art without impairing user convenience.

Hereinafter, the disclosure will be described in further detail using the drawings. Note that the following description is illustrative in all aspects, and it should not be understood that the description limits the disclosure.

### First Embodiment

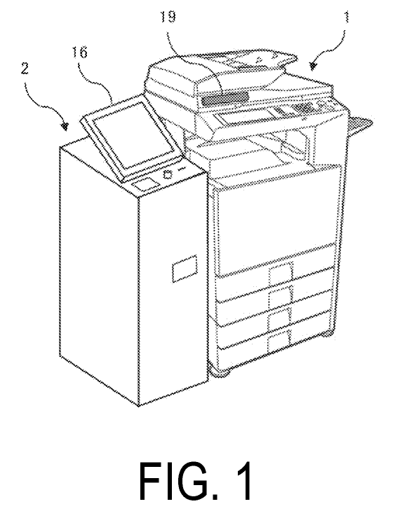

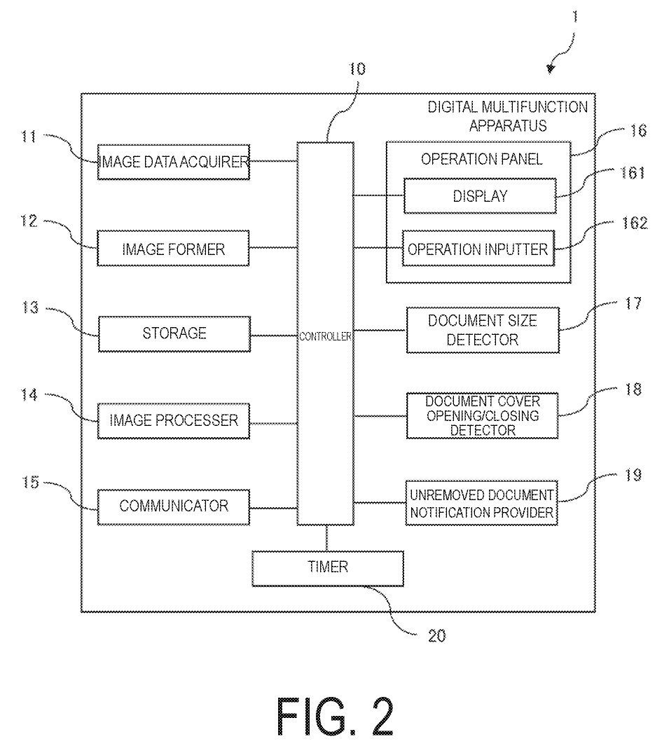

A digital multifunction apparatus 1 that is an embodiment of an image forming apparatus of the disclosure will be described based on FIGS. 1 and 2.

FIG. 1 is a perspective view illustrating an external appearance of the digital multifunction apparatus 1 of a first embodiment of the disclosure.

As illustrated in FIG. 1, an unremoved document notification provider 19 (described below) is provided on a document table.

A coin vendor 2 is provided beside the digital multifunction apparatus 1, and an operation panel 16 is provided on the coin vendor 2.

The digital multifunction apparatus 1 is an apparatus such as a multifunction apparatus or an MFP that digitally processes image data and has a copying function, a printer function, a scanner function, and a facsimile function.

The coin vendor 2 is a device that charges money, that is, the device in which coins or bills are put, according to the number of print jobs, the paper size, and the like.

The coin vendor 2 includes a housing, a refund button, and a coin slot.

The coin vendor 2 in which money is inserted may not be provided, and, for example, a predetermined card or electronic money may be used.

FIG. 2 is a block diagram illustrating a schematic configuration of the digital multifunction apparatus 1 of FIG. 1.

As illustrated in FIG. 2, the digital multifunction apparatus 1 includes a controller 10, an image data acquirer 11, an image former 12, a storage 13, an image processor 14, a communicator 15, an operation panel 16, a document size detector 17, a document cover opening/closing detector 18, the unremoved document notification provider 19, and a timer 20.

Hereinafter, components of the digital multifunction apparatus 1 will be described.

The controller 10 collectively controls the digital multifunction apparatus 1, and includes at least one central processing unit (CPU), at least one system on a chip (SoC), at least one random access memory (RAM), at least one read only memory (ROM), at least one control circuit, various interface circuits, and the like.

The controller 10 monitors and controls detection of each sensor and all loads such as a motor, a clutch, and the operation panel 16 to control overall operation of the digital multifunction apparatus 1.

The image data acquirer 11 is a part that reads, by a document reader, a document placed on the document table and acquires image data.

Further, the image data acquirer 11 may acquire image data in a USB via a USB connector (not illustrated) or the like.

Furthermore, the image data may be acquired from an external terminal or the like via a wired or wireless network (not illustrated).

The image former 12 is a part that prints the image data acquired by the image data acquirer 11 and processed by the image processor 14 onto a sheet and outputs the sheet.

The storage 13 is an element or a storage medium that stores information necessary to enable various functions of the digital multifunction apparatus 1, control programs, and the like. For example, a semiconductor element such as a RAM or a ROM or a storage medium such as a hard disk, a flash storage, or a solid state drive (SSD) is used.

The storage 13 stores information on a job related to a service such as printing and data required to execute the job such as image data.

Note that the program and the data may be held in different devices to form a region for holding data as a hard disk drive and a region for holding the program as a flash storage.

The image processor 14 converts the image data input from the image data acquirer 11 into an appropriate electrical signal based on analysis results of commands for jobs such as printing obtained from an operation inputter 162, and processes the signal appropriately for output such as enlargement or reduction.

The communicator 15 is a part that communicates with an external terminal (not illustrated) or the like via a network and transmits and receives various pieces of data.

The operation panel 16 includes a display panel composed of a liquid crystal panel or the like, and a touch panel of a capacitive touch system or the like that is arranged to overlap the display panel and detects a position touched with a finger, and includes a display 161 and the operation inputter 162.

The display 161 is a part that displays a variety of information.

The display 161 includes, for example, a CRT display, a liquid crystal display, an EL display, or the like, and is a display device such as a monitor used by an operating system and application software to display electronic data such as a processing status.

The operation inputter 162 is an interface for operating the digital multifunction apparatus 1 and accepts commands from a user.

The document size detector 17 is a sensor that detects a document (document size) placed on the document table.

The document size detector 17 can detect the size of the document even in a state where the document cover is open.

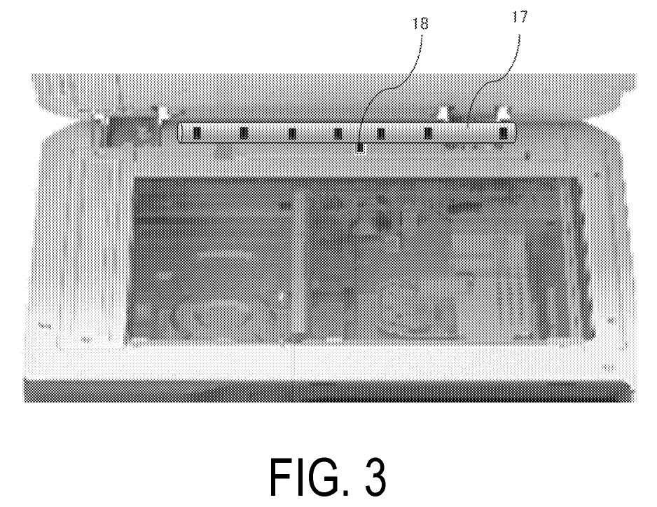

FIG. 3 is an explanatory diagram illustrating an example of the document size detector 17 and the document cover opening/closing detector 18 that are provided on the document table of the digital multifunction apparatus 1 of FIG. 1.

As illustrated in FIG. 3, the document size detector 17 is provided with a plurality of optical sensors at positions corresponding to paper sizes such as A5, B4, A4, B4, A3, and B3, and the size of the document can be determined based on the detection result of reflected light when the document is irradiated with light by each optical sensor.

Since there is a minimum size (for example, A5 size, B5 size, or the like) of a detectable document depending on the position of the optical sensor, the document cover opening/closing detector 18 cannot detect a document (for example, the size of a business card, a driver's license, a My Number Card, an L-size/2L-size photograph, or the like) equal to or smaller than the minimum size.

The document cover opening/closing detector 18 is a sensor that detects an open/closed state of the document cover.

As illustrated in FIG. 3, the document cover opening/closing detector 18 can determine whether the document cover is closed based on the detection result of reflected light when light is emitted upward.

The unremoved document notification provider 19 is a part that notifies that the document is forgotten to be removed, and includes an LED and a speaker.

As illustrated in FIG. 1, the unremoved document notification provider 19 is provided at a position easily and visually recognized by the user around the document cover of the document table, and when the document is forgotten to be removed, the unremoved document notification provider 19 blinks the LED at predetermined intervals and outputs a notification sound via the speaker, thereby prompting the user to prevent forgetting to remove the document.

In particular, even when the notification sound is difficult to hear in a noisy environment such as the inside of a convenience store, the LED is blinked, and thus advantageously, the user's attention is more easily drawn than in the related art.

The timer 20 is a part that measures and counts time, and acquires, for example, a clock time via an incorporated clock or a network.

Example of Document Removal Forgetting Prevention Processing of Digital Multifunction Apparatus 1 according to First Embodiment of the Disclosure

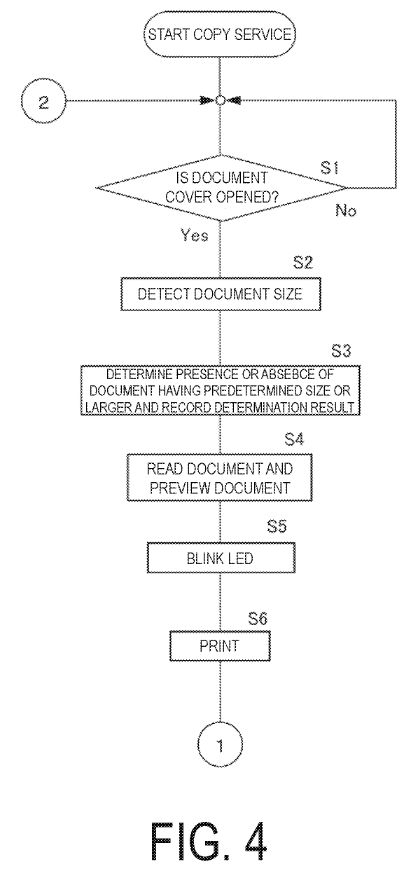

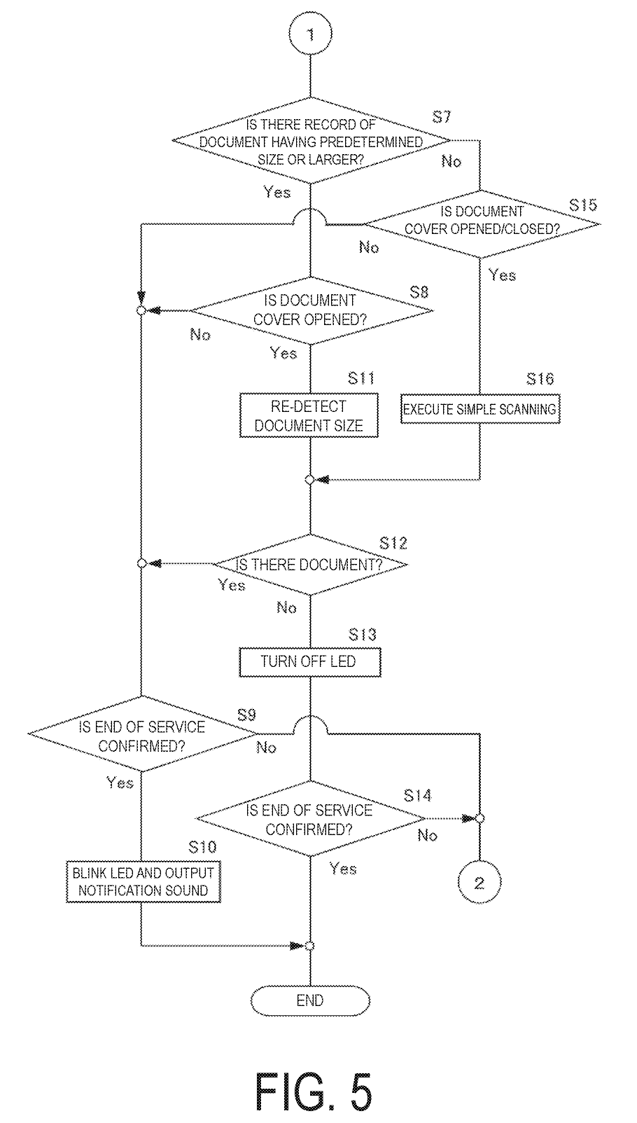

Next, an example of document removal forgetting prevention processing of the digital multifunction apparatus 1 according to the first embodiment of the disclosure will be described based on FIGS. 4 and 5.

FIGS. 4 and 5 are each a flowchart illustrating an example of document removal forgetting prevention processing by the digital multifunction apparatus 1 of FIG. 1.

In the following description, a case where an instruction to start a job related to a copy service is received will be described as an example, but the job is not limited to the job related to the copy service, and may be a job related to another service, for example, as long as the job is a job related to another service such as scanning, e-mail transmission, or FAX transmission and involves reading of a document.

In FIG. 4, it is assumed that the payment to the coin vendor 2 is confirmed and thereafter an instruction to start a job related to a copy service is received.

In the following steps, by allowing the document cover opening/closing detector 18 to detect the open/closed state of the document cover, whether the document is forgotten to be removed is determined. When the document is forgotten to be removed, processing of prompting the user to prevent from forgetting to remove the document.

In step S1, the controller 10 determines whether the document cover opening/closing detector 18 has detected that the document cover is opened (step S1).

When the document cover opening/closing detector 18 has not detected that the document cover is opened (when the determination in step S1 is No), the controller 10 repeats the determination in step S1.

On the other hand, when the document cover opening/closing detector 18 has detected that the document cover is opened (when the determination in step S1 is YES), in step S2, the controller 10 allows the document size detector 17 to detect the size of a document (step S2).

Next, in step S3, the controller 10 determines the presence or absence of the document based on the detection result of the document size detector 17, and stores the determination result in the storage 13 (step S3).

Note that since a document (for example, a business card or the like) having a size equal to or smaller than the minimum size that can be detected by the document size detector 17 is not detected, it is determined that there is no document.

In addition, in a case where the service is continued even after the execution of a copy job and the user replaces a plurality of documents and executes another copy job (in a case where the processing returns from step S9 or S13 in FIG. 5), the controller 10 stores only the latest determination result in the storage 13 and deletes the old determination result from the storage 13.

Next, in step S4, the controller 10 allows the image data acquirer 11 to read the document and allows the display 161 to preview the acquired image (step S4).

Next, in step S5, the controller 10 allows the unremoved document notification provider 19 (step S5) to blink the LED.

In this manner, by blinking the LED after previewing, the user can recognize that the document is present on the document table.

Next, in step S6, the controller 10 allows the image former 12 to print the image (step S6).

Subsequently, after the completion of printing, in step S7 of FIG. 5, the controller 10 refers to the result stored in the storage 13 in step S3, and determines whether a document having the predetermined size or larger is present (step S7).

When the document having the predetermined size or larger is present (when the determination in step S7 is Yes), in step S8, the controller 10 determines whether the document cover opening/closing detector 18 has detected after the completion of printing that the document cover is opened before a predetermined standby time (for example, 10 seconds) elapses (step S8).

After the completion of printing, the document cover opening/closing detector 18 has not detected that the document cover is opened before the predetermined standby time elapses (when the determination in step S8 is No). In such a case, in step S9, the controller 10 determines whether the end of the service is confirmed (step S9).

For example, in a case where a service end button displayed on the screen of the copy service is pressed, or a case where after the completion of printing, a predetermined standby time has elapsed in a state where the operation inputter 162 does not receive any operation, the controller 10 determines that the end of the service is confirmed.

On the other hand, in a case where the end of the service is not confirmed (when the determination in step S9 is No), the controller 10 returns the processing to the determination in step S1 in order to continue the service.

On the other hand, in a case where the end of the service is confirmed (when the determination in step S9 is Yes), in step S10, the controller 10 allows the unremoved document notification provider 19 to blink the LED and output a notification sound from the speaker (step S10), and ends the processing.

On the other hand, in step S8, after the completion of printing, the document cover opening/closing detector 18 has detected that the document cover is opened before the predetermined standby time elapses (when the determination in step S8 is Yes). In such a case, in step S11, the controller 10 allows the document size detector 17 to detect the document size again (step S11).

Next, in step S12, the controller 10 determines the presence or absence of the document based on the detection result of the document size detector 17 (step S12).

In a case where the document is present (when the determination in step S12 is YES), in step S9, the controller 10 determines whether the end of the service is confirmed.

On the other hand, in a case where there is no document (when the determination in step S12 is No), in step S13, the controller 10 allows the unremoved document notification provider 19 to turn off the LED (step S13).

In this manner, the LED is blinked after previewing; thereafter, the LED of the unremoved document notification provider 19 is continued to blink until it is determined that no document is left behind, and thus the user can be aware of the presence of the document.

On the other hand, in a case where the end of the service is determined in a state where the document is left behind, the unremoved document notification provider 19 blinks the LED, and the notification sound is output from the speaker. Thus, the document can be effectively prevented from being forgotten to be removed.

Next, in step S14, the controller 10 determines whether the end of the service is confirmed (step S14).

In a case where the end of the service is not confirmed (when the determination in step S14 is No), the controller 10 returns the processing to the determination in step S1 in order to continue the service.

On the other hand, in a case where the end of the service is confirmed (when the determination in step S14 is Yes), the controller 10 ends the processing.

In addition, in step S7, in a case where there is no document having the predetermined size or larger with reference to the result stored in the storage 13 (when the determination in step S7 is No), in step S15, the controller 10 determines after the completion of printing whether the document cover opening/closing detector 18 has detected that the document cover is opened/closed before the predetermined standby time elapses (step S15).

After the completion of printing, the document cover opening/closing detector 18 has not detected that the document cover is opened/closed before the predetermined standby time elapses (when the determination in step S15 is No). In such a case, in step S9, the controller 10 determines whether the end of the service is confirmed.

Note that even in a case where the document cover is opened but not closed, the controller 10 shifts the processing to the determination in step S9, but this is because a situation is assumed in which in the case of continuing the service, the user sets the next document without closing the document cover.

On the other hand, after the completion of printing, the document cover opening/closing detector 18 has detected that the document cover is opened/closed before the predetermined standby time elapses (when the determination in step S15 is Yes). In such a case, in step S16, the controller 10 allows the image data acquirer 11 to execute simple scanning (step S16).

In this manner, by performing simple scanning only when the predetermined conditions of steps S7 and S15 are satisfied, the user can be effectively prevented from forgetting to remove the document with less power consumption in the related art without making the user wait.

Since such simple scanning is performed to confirm whether the document having a size smaller than the predetermined size, such as a business card, is left behind on the document table, the resolution may be lower than the resolution at the time of normal reading. In addition, the scanning range may be limited to a range smaller than the predetermined size. Thus, the time required for scanning is reduced compared to pre-scanning in the related art, and power consumption is also reduced.

Subsequently, in step S12, the controller 10 determines the presence or absence of the document based on the analysis result of simple scanning (step S12).

As a result, a case where the document having a size smaller than the predetermined size, such as a business card is left behind on the document table also can be detected.

As just described, after the completion of printing, when it is detected that the document cover is opened before the predetermined standby time elapses, the size of the document is detected again and the document is detected. In such a case, the user is notified that the document is forgotten to be removed. On the other hand, when it is not detected that the document cover is opened, the user is notified that the document is forgotten to be removed, and thus the digital multifunction apparatus 1 can be achieved that effectively prevents forgetting to remove the document with less power consumption than in the related art without impairing user convenience.

Preferred aspects of the disclosure include any combinations of a plurality of aspects described above.

In addition to the aforementioned embodiments, various modifications of the disclosure are possible. It should not be understood that the modifications do not belong to the scope of the disclosure. The disclosure shall include meanings equivalent to the scope of claims and all modifications within the scope.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image forming apparatus, comprising:
an operation inputter that receives an execution command of a service involving reading of a document from a user;
a document reader that reads the document placed on a document table and generates image data based on an execution command of a job related to the service;
an image outputter that outputs an image formed based on the image data;
a document size detector that detects a size of the document placed on the document table;
a storage that stores the size of the document;
a document cover opening/closing detector that detects opening/closing of a document cover of the document table;
an unremoved document notification provider that notifies that the document is forgotten to be removed from the document table; and
one or a plurality of controllers that control the operation inputter, the document reader, the image outputter, the document size detector, the storage, the document cover opening/closing detector, and the unremoved document notification provider,
wherein when the document cover opening/closing detector detects that the document cover is opened at start of the job, the controller allows the storage to store the size of the document detected by the document size detector,
after completion of the job, in a case where the document cover opening/closing detector detects that the document cover is opened before a predetermined standby time elapses, the document size detector is allowed to detect the size of the document again, and in a case where the document is detected, the unremoved document notification provider is allowed to notify that the document is forgotten to be removed, and
on the other hand, in a case where even after the standby time has elapsed, the document cover opening/closing detector does not detect that the document cover is opened, the unremoved document notification provider is allowed to notify that the document is forgotten to be removed.

2. The image forming apparatus according to claim 1, wherein the document size detector detects the size of the document, which is a predetermined size or larger,
when the document cover opening/closing detector detects that the document cover is opened at the start of the job, the controller allows the storage to store the size of the document, which is detected by the document size detector and is the predetermined size or larger,
after the completion of the job, in a case where the size of the document, which is the predetermined size or larger is not stored in the storage, the document reader is allowed to read the document placed on the document table when the document cover opening/closing detector detects opening/closing of the document cover before the standby time elapses, and in a case where the document is detected, the unremoved document notification provider is allowed to notify that the document is forgotten to be removed.

3. The image forming apparatus according to claim 2, wherein after the completion of the job, the size of the document, which is the predetermined size or larger is not stored in the storage, and in such a case, when the document cover opening/closing detector detects opening/closing of the document cover before the standby time elapses, the controller allows the document reader to read the document placed on the document table in a predetermined range smaller than the predetermined size.

4. The image forming apparatus according to claim 1, wherein the unremoved document notification provider includes a light emitter provided around the document cover, and
after an end of the service is confirmed, the light emitter is blinked to notify that the document is forgotten to be removed.

5. The image forming apparatus according to claim 4, further comprising a display that previews the document read by the document reader to a user,
wherein the controller allows the storage to store the size of the document detected by the document size detector; thereafter, allows the document reader to read the document placed on the document table, allows the display to preview the document, and allows the unremoved document notification provider to blink the light emitter, and
after the completion of the job, the document reader is allowed to read the document placed on the document table before the standby time elapses, and in a case where the document is not detected, the unremoved document notification provider is allowed to turn off the light emitter.
